(19) United States
(12) Patent Application Publication
(10) Pub. No.: US 2022/0395416 A1
(43) Pub. Date: Dec. 15, 2022

(54) LEG-HOLDING DEVICE FOR HIP OR KNEE SURGERY AND ARRANGEMENT METHOD THEREOF

(71) Applicant: MATHYS AG BETTLACH, Bettlach (CH)

(72) Inventor: Patrick FELL, Auckland (NZ)

(21) Appl. No.: 17/771,278

(22) PCT Filed: Oct. 20, 2020
(86) PCT No.: PCT/EP2020/079473

§ 371 Date: Apr. 22, 2022

(30) Foreign Application Priority Data
Oct. 25, 2019 (EP) 19205231.4

(51) Int. Cl. A61G 13/12; A61G 13/10

(52) U.S. Cl. CPC A61G 13/125; A61G 13/101

(57) ABSTRACT

A leg-holding device for hip or knee surgery is provided. The device comprises a support fixture adapted to fasten the device on an edge of a surface. In addition, the device comprises a main frame arranged on the support fixture in a detachable manner, adapted to move along a first lateral axis and a first rotational axis with respect to the support fixture. Furthermore, the device comprises a rotating frame arranged on the main frame in a detachable manner, adapted to move along a second lateral axis and a second rotational axis with respect to the main frame. Moreover, the device comprises a foot plate arranged on the rotating frame in a detachable manner, adapted to move along a third lateral axis and a third rotational axis with respect to the rotating frame.

### PRIORITY

This application claims priority of European Patent Application EP 19 205 231.4 filed on Oct. 25, 2019, which is incorporated by reference herewith.

### FIELD OF THE INVENTION

The invention relates to a leg-holding device and an arrangement method of said device for hip or knee surgery, for instance, in the case of a hip arthroplasty, which allows the leg of a patient to be rotated and held, especially in external rotation.

### BACKGROUND OF THE INVENTION

Generally, wide ranges of positioning devices are utilized in surgical procedures, depending on the nature of the surgery as well as the choice of surgical approach (e.g. posterior, anterior, and lateral). In the case of a hip or knee surgery, distraction units are utilized for positioning the leg and/or the knee of a patient, which are normally attached to a standard operating table and are dedicated to a specific choice of surgical approach. The prior distraction units are either strictly dedicated to the nature of the surgery or of considerable size with complex mechanisms. For the latter case, the distraction units can be stand-alone units or assimilated with the operating table, however they consume a significant amount of resources (e.g., man-power, energy) due to their demanding and complex nature of operation.

For example, the document CN 203885627 U shows an adjustable fixation surgical knee distraction device for holding the knee of a patient at 90 degrees, especially for driving the tension on tibia away from femur. However, the distraction device is dedicated to knee surgery and does not support external rotation on the leg, for instance, for a patient in lateral decubitus position in order to allow holding of leg in hip extension and adduction.

Accordingly, there is a need to provide a leg-holding device for hip or knee surgery and an arrangement method thereof in a lightweight and cost-effective manner, which further supports the lateral decubitus position for hip and/or knee adduction.

### SUMMARY OF THE INVENTION

According to a first aspect of the invention, a leg-holding device for hip or knee surgery is provided. The device comprises a support fixture adapted to fasten the device on an edge of a surface. In addition, the device comprises a main frame arranged on the support fixture in a detachable manner, adapted to move along a first lateral axis and a first rotational axis with respect to the support fixture. Furthermore, the device comprises a rotating frame arranged on the main frame in a detachable manner, adapted to move along a second lateral axis and a second rotational axis with respect to the main frame. Moreover, the device comprises a foot plate arranged on the rotating frame in a detachable manner, adapted to move along a third lateral axis and a third rotational axis with respect to the rotating frame.

In this context, the first lateral axis and the first rotational axis are parallel to the third lateral axis and the third rotational axis respectively. Moreover, the first and third lateral axes and the first and third rotational axes are perpendicular to the second lateral axis and the second rotational axis respectively.

Therefore, a leg-holding device is provided in a simple and cost-effective manner that facilitates numerous degrees of freedom in order to manipulate the leg position during a surgery. Especially, the frames and the foot plate are formed in a light-weight and detachable manner, which advantageously allows for moving the leg easily and quickly during the surgical procedure, for instance, for externally rotating the leg 90 degrees to each other. Furthermore, the detachable foot plate along the rotating frame as well as the detachable rotating frame along the main frame permit quick detachment and/or reattachment of a leg to the device for easy reduction and/or dislocation.

According to a first preferred implementation form of said first aspect of the invention, the support fixture comprises a first fastening element and a second fastening element, where the first fastening element is adapted to fasten the main frame at a given lateral displacement along the first lateral axis and a given rotational angle along the first rotational axis. In addition, the second fastening element is adapted to fasten the support fixture on the edge of the surface. Advantageously, the main frame resp. the device can be adjusted to a certain height and a certain angle with respect to the surface on which the device is attached, for instance, an edge of an operating table.

According to a second preferred implementation form of said first aspect of the invention, the main frame comprises an L-shaped member having a fixed end and a free end and a hollow cylinder, where the fixed end is attached to a midpoint of the hollow cylinder and the free end is arranged on the support fixture. Herein, the free end and the fixed end can be welded together to formulate the L-shaped member where the free end is preferably displaced by 90 degrees with respect to the fixed end. The fixed end can either be bolted or welded to the hollow cylinder for formulating a T junction at the intersection.

According to a further preferred implementation form of said first aspect of the invention, the rotating frame comprises an L-shaped member having a first end and a second end, where the first end is arranged through the hollow cylinder perpendicular to the fixed end of the main frame. In this context, the first end and the second end can be welded together to form the L-shaped member and the inner diameter of the hollow cylinder is sufficiently large to encompass the first end while allowing the first end resp. the rotating frame to be rotated.

According to a further preferred implementation form of said first aspect of the invention, the hollow cylinder comprises a screw hole opposite to the fixed end of the main frame. In addition, the device further comprises a locking mechanism arranged at the screw hole, adapted to fasten the first end of the rotating frame at a given lateral displacement along the second lateral axis and a given rotational angle along the second rotational axis. Advantageously, the rotating frame can be adjusted to a certain length based on the required distance between the main frame and the foot plate. Moreover, the rotating frame can be adjusted to a certain angle regarding the main frame in order to facilitate 360 degrees rotation of the foot plate along a plane perpendicular to the surface on which the device is attached.

According to a further preferred implementation form of said first aspect of the invention, the foot plate comprises a vertical support plate and a horizontal support plate attached on a surface perpendicular to each other. Advantageously, the support plates allow for convenient placement of a foot on the foot plate and further simplify the attachment of a leg on the device. Moreover, the foot plate offers significant adaptability with regard to different foot size respective to different patients.

According to a further preferred implementation form of said first aspect of the invention, the foot plate further comprises a hollow cylindrical tube attached to the back of the foot plate, adapted to be positioned on the second end of the rotating frame at a given lateral displacement along the third lateral axis and a given rotational angle along the third rotational axis. The cylindrical tube along with the support plates advantageously allow for easy binding of a foot on the foot plate while providing adequate view of the heel and foot for leg length comparison.

Herein, the inertia of the attached leg and the gravity will be enough to position the foot plate on the rotating frame at a certain angle. Additionally or alternately, the cylindrical tube may comprise additional locking arrangement in order to position the foot plate at a certain angle and a certain height on the second end of the rotating frame.

According to a further preferred implementation form of said first aspect of the invention, the main frame further comprises a first frame segment and a second frame segment, each comprising a member having a fixed end and a free end. In this context, the fixed ends of the members are attached to a respective hollow cylinder. Preferably, the first frame segment and the second frame segment are identical in dimensions and shapes, where the fixed end of each member is bolted or welded to a mid-point of a respective hollow cylinder. Advantageously, additional set-up flexibility is incorporated.

According to a further preferred implementation form of said first aspect of the invention, the hollow cylinders of the first frame segment and the second frame segment each comprises a screw hole opposite to the respective fixed ends of the members in order to facilitate the locking mechanism. In this context, the free end of the first frame segment is arranged through the hollow cylinder of the second frame segment perpendicular to the member of the second frame segment and is further fastened by the respective locking mechanism at a given lateral displacement along a fourth lateral axis and a given rotational angle along a fourth rotational axis.

Moreover, the free end of the second frame segment is arranged on the support fixture and is fastened at a given lateral displacement along the first lateral axis and a given rotational angle along the first rotational axis. Advantageously, at least one additional degree of freedom is therefore introduced.

According to a further preferred implementation form of said first aspect of the invention, the support fixture, the main frame, the rotating frame, the foot plate and the locking mechanism are adapted to be sterilized in a compact arrangement. Advantageously, the device can be operated within the sterile field, preferably by the surgeon him/her-self during a medical procedure.

According to a second aspect of the invention, a method for arranging a leg-holder device comprising a support fixture, a main frame, a rotating frame and a foot plate is provided. The method comprises the step of arranging the main frame on the support fixture in a detachable manner so as to move along a first lateral axis and a first rotational axis with respect to the support fixture. The method further comprises the step of arranging the rotating frame on the main frame in a detachable manner so as to move along a second lateral axis and a second rotational axis with respect to the main frame. Moreover, the method comprises the step of arranging the foot plate on the rotating frame in a detachable manner so as to move along a third lateral axis and a third rotational axis with respect to the rotating frame. Advantageously, numerous degrees of freedom are facilitated in a simple and cost-effective manner for rotating and holding the leg during a surgery.

### BRIEF DESCRIPTION OF THE DRAWINGS

Exemplary embodiments of the invention are now further explained with respect to the drawings by way of example only, and not for limitation. In the drawings:

FIG. 1 shows a three-dimensional view of a first exemplary embodiment of the device according to the first aspect of the invention;

FIG. 2 shows a side view of an exemplary embodiment of the support fixture according to the first aspect of the invention;

FIG. 3A shows a side view of a first exemplary embodiment of the main frame according to the first aspect of the invention;

FIG. 3B shows a front view of the first exemplary embodiment of the main frame according to the first aspect of the invention;

FIG. 3C shows a top view of the first exemplary embodiment of the main frame according to the first aspect of the invention;

FIG. 4 shows a side view of a first exemplary embodiment of the rotating frame according to the first aspect of the invention;

FIG. 5A shows a front view of an exemplary embodiment of the foot plate according to the first aspect of the invention;

FIG. 5B shows a side view of the exemplary embodiment of the foot plate according to the first aspect of the invention;

FIG. 5C shows a bottom view of the exemplary embodiment of the foot plate according to the first aspect of the invention;

FIG. 6A shows a front view of an exemplary embodiment of the locking mechanism according to the first aspect of the invention;

FIG. 6B shows a side view of the exemplary embodiment of the locking mechanism according to the first aspect of the invention;

FIG. 6C shows a top view of the exemplary embodiment of the locking mechanism according to the first aspect of the invention;

FIG. 7 shows a three-dimensional view of an exemplary arrangement of the main frame, rotating frame and the locking mechanism according to the first aspect of the invention;

FIG. 8A shows a side view of a second exemplary embodiment of the main frame according to the first aspect of the invention;

FIG. 8B shows a top view of the second exemplary embodiment of the main frame according to the first aspect of the invention;

FIG. 9 shows a three-dimensional view of the second exemplary embodiment of the main frame according to the first aspect of the invention;

FIG. 10 shows a three-dimensional view of a second exemplary embodiment of the device according to the first aspect of the invention;

FIG. 11A shows a side view of a second exemplary embodiment of the rotating frame according to the first aspect of the invention;

FIG. 11B shows a three-dimensional view for an arrangement of the second exemplary embodiment of the rotating frame according to the first aspect of the invention; and

FIG. 12 shows an exemplary embodiment of the method according to the second aspect of the invention.

### DETAILED DESCRIPTION OF PREFERRED EMBODIMENTS

Reference will now be made in detail to the embodiments of the present invention, examples of which are illustrated in the accompanying drawings. However, the following embodiments of the present invention may be variously modified and the range of the present invention is not limited by the following embodiments.

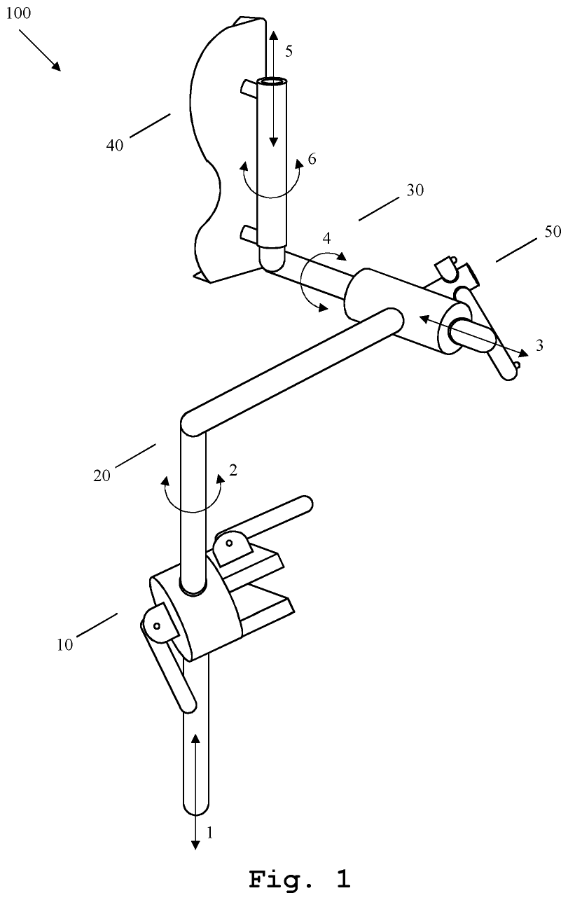

In FIG. 1, a three-dimensional view of a first exemplary embodiment of the device 100 according to the first aspect of the invention is illustrated. The device 100 comprises a support fixture 10, a main frame 20, a rotating frame 30, a foot plate 40 and a locking mechanism 50, which are attached to each other in a detachable manner. Especially, the main frame is movable through the support fixture 10 along a first linear axis 1 and is rotatable along a first rotational axis 2. The rotating frame 30 is movable through the main frame 20 along a second linear axis 3 and is rotatable along a second rotational axis 4. The foot plate 40 is placed onto the rotating frame 30, where the foot plate 40 is movable along a third linear axis 5 and is rotatable along a third rotational axis 6. Each of the sections are described in detail in the following embodiments.

It is to be noted that the choice of the surgical approach plays a vital role for selecting an appropriate distraction device. For instance, the posterior approach, which is most commonly used approach among the surgeons, especially in hip surgeries, allows a better and wider visibility and possibility of manipulation of leg position, while allowing less comfort compared to other approaches. On the other hand, in the direct anterior approach patients seemed to have less postoperative pain, however, is associated with higher complication rates and difficult femoral component positioning. An anterior approach on a patient in lateral decubitus, i.e., the anterior approach in side position seems to overcome the complexities of the foregoing approaches, especially allows secure component positioning as well as leg length comparison. The device 100 is not only adapted to the direct anterior approach but also for patients in lateral decubitus due to the linear and rotational movements of the separable sections, which advantageously facilitate six degrees of freedom of operation.

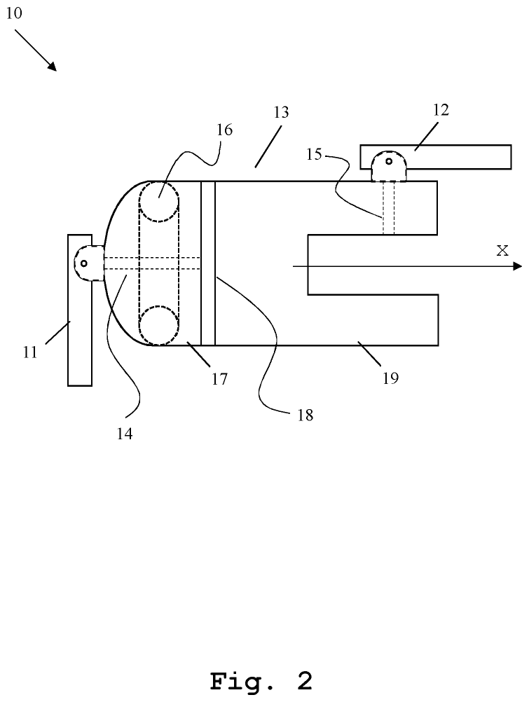

In FIG. 2, a side view of an exemplary embodiment of the support fixture 10 according to the first aspect of the invention is illustrated. The support fixture 10 comprises a first fastening element 11, a second fastening element 12 and a frame body 13. The frame body 13 has a moving section 17 and a fixed section 19. The moving section 17 comprises a conduit 16 through the body in order to encompass the main frame 30. The first fastening element 11 is attached to a bolt 14 through which the end of the main frame 20 is fixed. Similarly, the second fastening element 12 is attached to a bolt 15 through which the frame body 13 is fixed on an edge of a surface, for instance, at the edge of an operating table.

Furthermore, the moving section 17 and the fixed section 19 are attached to each other on a channel 18, via which the moving section 17 is able to rotate along a plane perpendicular to the axis X of the fastening plane. Therefore, the support fixture 10 additionally allows the device 100 to be rotated along the edge of the operating table and thereby configures the device 100 to be adapted for different leg placement distances, for instance, for different heights of patients.

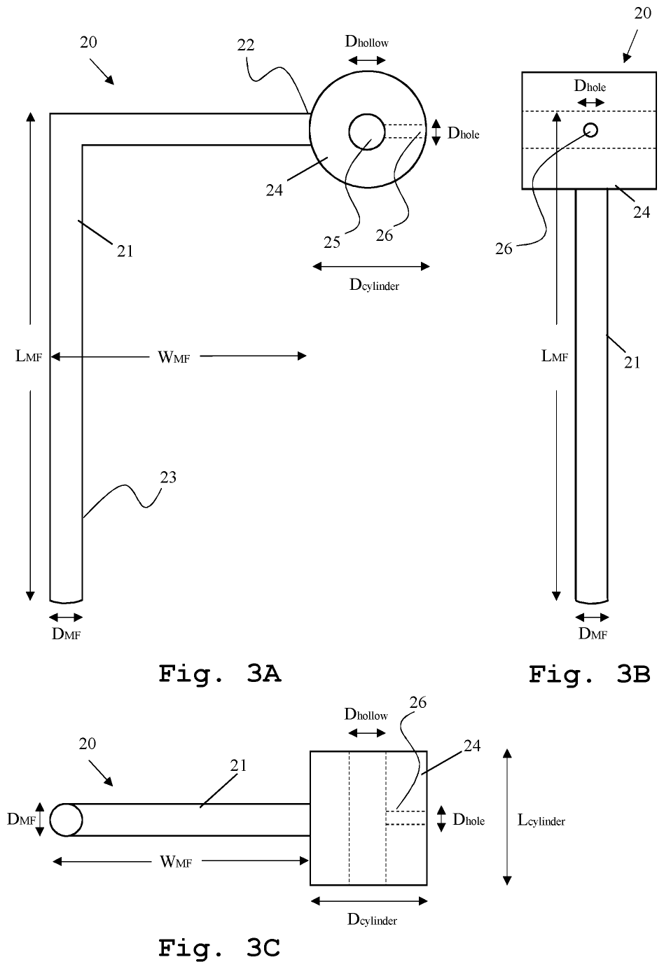

Along FIG. 3A, FIG. 3B and FIG. 3C, a first exemplary embodiment of the main frame 20 according to the first aspect of the invention are illustrated. In particular, FIG. 3A shows a side view of the main frame 20, which comprises an L-shaped member 21 in the form of a solid tube and a hollow cylinder 24 with a conduit 25. The L-shaped member 21 has a fixed end 22 and a free end 23, where the fixed end 22 is welded to the hollow cylinder 24 at around a mid-point and forming a T-joint at the intersection. The free end 23 is positioned through the conduit 16 of the support fixture 10 as described above. The hollow cylinder 24 has a screw hole 26, which is threaded at the opposite end of the T-joint.

The dimensions of the main frame 20 is kept to a minimum in order to facilitate a compact arrangement. For instance, the length or height L_{MF} of the main frame 20, i.e., the longitudinal distance between the edge of the free end 23 to the T-joint can be 350 mm. The length L_{MF} of the main frame 20 primarily controls the effective height of the device 100 along which the height of the device 100 can be adjusted with respect to the fastening edge of the operating table. The width or displacement W_{MF} of the main frame 20, i.e., the lateral distance between the free end 23 and the T-joint can be 150 mm. The diameter D_{MF} of the L-shaped member 21 i.e., the thickness of the tube can be 16 mm. Furthermore, the outer diameter D_{cylinder} of the hollow cylinder 24 can be 40 mm while the inner diameter D_{hollow} or the diameter of the conduit 25 can be 16 mm. The screw hole 26 may comprise a diameter Dₕₒₗₑ of 8 mm.

Along FIG. 3B, a front view of the main frame 20 is illustrated. Herein, the respective positions for the screw hole 26 as well as for the member 21 with regard to the hollow cylinder 24 are visibly projected.

Along FIG. 3C, a top view of the main frame 20 is illustrated. The axial positions of the screw hole 26 and the member 21 are projected herein along the length of the hollow cylinder 24. In this context, the length L_{cylinder} of the hollow cylinder 24 can be approximately 65 mm.

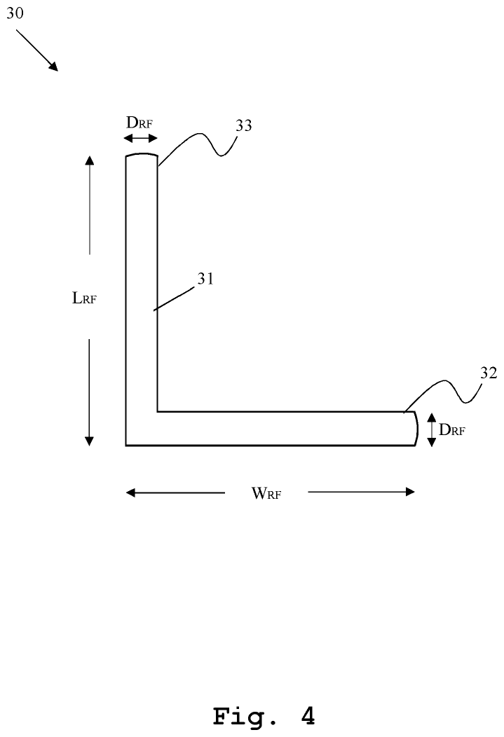

In FIG. 4, a side view of a first exemplary embodiment of the rotating frame 30 according to the first aspect of the invention is illustrated. The rotating frame 30 is also in the form of an L-shaped member 31, preferably a solid tubular form. The rotating frame 30 has a first end 32 and a second end 33, where the first end 32 is positioned through the conduit 25 of the hollow cylinder 24. Thus, the rotating frame 30 is movable along the length of the hollow cylinder perpendicular to the fixed end 22 of the main frame 20. The dimensions of the rotating frame 30 can also be approximated in line with the dimensions of the main frame 20.

For instance, the height or length L_{RF} of the rotating frame 30, i.e., the longitudinal distance between the first end 32 and the second end 33 can be 150 mm. Similarly, the width W_{RF} of the rotating frame 30, i.e., the lateral distance between the first end 32 and the second end 33 can be 150 mm. In this context, the width W_{RF} of the rotating frame 30 principally controls the effective positioning of the device 100 along which the distance of the device 100 can be adjusted with respect to the position of a foot of a patient. The tubular L-shaped member 31 may comprise a diameter D_{RF} of 16 mm, symmetrical to the inner diameter of the hollow cylinder 24 of the main frame 20. In addition, a portion of the first end 32 can be threaded with roots and crests in order to provide better fastening along the length of the hollow cylinder 24.

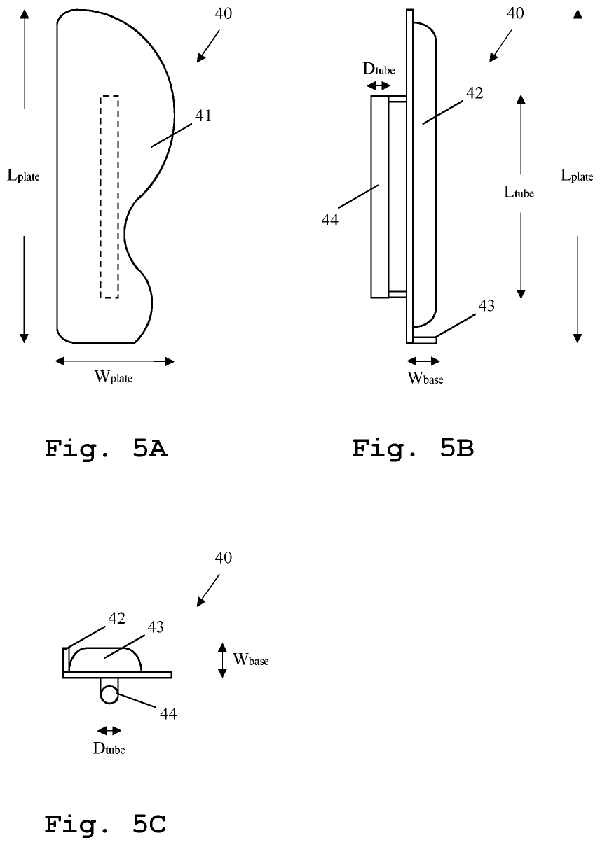

Along FIG. 5A, FIG. 5B and FIG. 5C, an exemplary embodiment of the foot plate 40 according to the first aspect of the invention are illustrated. In particular, FIG. 5A shows a front view of the foot plate 40, especially the surface or the base plate 41 of the foot plate 40. In this context, a set of base plates 41 can be realized with a range of dimensions in order to facilitate different foot sizes for different patients. Alternately, the base plate 40 can be segmented, for instance, in two separate segments and can be loaded on a spring locked channel in-between the segments in order to adjust the height of the foot plate 40. In either case, the foot plate 40 provides further flexibility during the medical procedure. Generally, the length Lₚₗₐₜₑ of the foot plate 40 is in the range of 200 mm to 270 mm and the width Wₚₗₐₜₑ of the foot plate 40 is in the range of 60 mm to 100 mm.

Along FIG. 5B, a side view of the foot plate 40 along with a vertical support plate 42 and a horizontal support plate 43 are illustrated. The support plates 42,43 are attached perpendicularly at the respective edges on the base plate 41 in order to support a foot on the foot plate 40. The support plates 42,43 can be welded at the respective edges on the base plate 41. Alternately, the support plates 42,43 can be attached on the base plate 41 by means of spring loaded sockets in order to firmly hold the foot of a patient on the foot plate 40. Furthermore, as an alternative to the foregoing arrangements, the support plates 42,43 may be realized by incorporating them into the shape of the base plate 41 in the metal sheet from which the base plate 41 is cut and then by subsequently bending the respective support plate portions to 90 degrees towards the frontal face of the base plate 41. The foot plate 40 further comprises a hollow cylindrical tube 44 attached to the back of the base plate 41 through which the second end 33 of the rotating frame 30 can be passed with ease.

During a medical procedure, a patient's foot is firmly placed on the foot plate 40 with additional paddings inserted in-between the foot and the foot plate 40. Additionally, the foot is bound to the foot plate 40, for instance, via bandage wrapped around both the foot and foot plate 40 for rigidity. Since the wrapping only covers along the tube 44, an adequate view of the heel and the foot are available in order to compare the leg lengths. Furthermore, the detachment/reattachment motion of the foot plate 40, especially along the second end 33 of the rotating frame 30, is conveyed along the interior of the tube 44. Hence, the wrapping or paddings do not interfere with the motion of the foot plate 40 when a foot is detached from or reattached to the device 100.

The width W_{base} of the vertical support plate 42 as well as the horizontal support plate 43 can be approximately 30 mm. The length L_{tube} of the hollow cylindrical tube 44 corresponds to the length or height of the rotating frame 30, i.e., 150 mm. In order to facilitate easy detachment or reattachment of the foot plate 40 on the second end 33 of the rotating frame 30, the diameter D_{tube} of the tube 44 is slightly greater than the diameter of the rotating frame 30, for instance, approximately 18 mm.

Along FIG. 5C, a bottom view of the foot plate 40 is shown. Herein, the axial positions of the vertical plate 42, the horizontal plate 43 and the hollow cylindrical tube 44 with respect to the base plate 41 are projected. It is to be noted that the base plate 41 has a shaped structure, preferably a shoe-sole shape having a wider upper section than the lower section for allowing additional holding on the foot to be attached. The foot is generally placed on the foot plate 40 in a way that the medial face of the foot is placed along the vertical support plate 42 and the heel is rested on the horizontal support plate 43. By way of this, the weight of the foot along with the gravity sufficiently lock the foot plate 40 on the second end 33 of the rotating frame 30 at a given angle. Alternately, the foot plate 40 may comprise additional locking arrangement, for instance, on the hollow cylindrical tube 44 in order to fasten the foot plate 40 along the rotating frame 30 at a desired angle and a desired displacement.

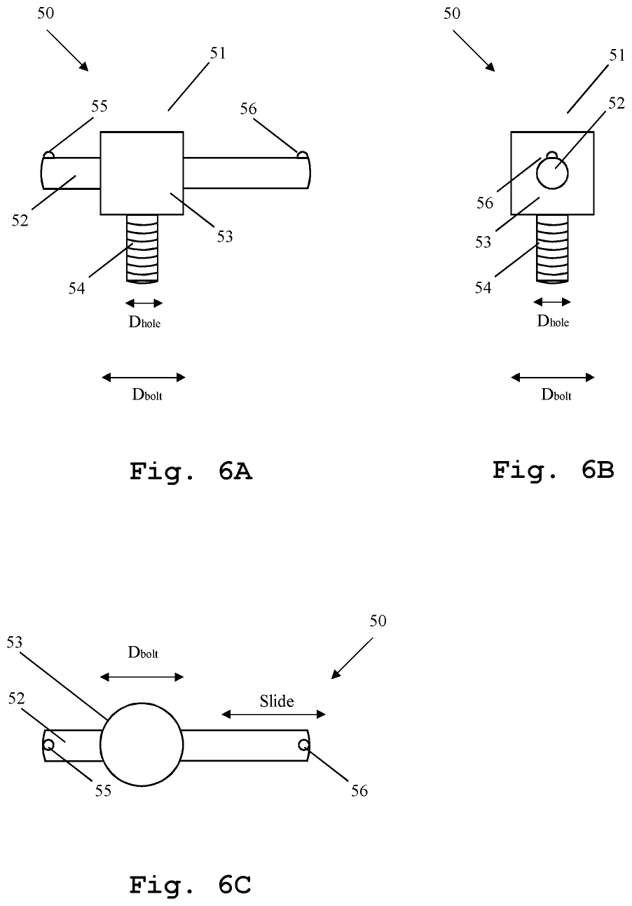

Along FIG. 6A, FIG. 6B and FIG. 6C, an exemplary embodiment of the locking mechanism 50 according to the first aspect of the invention are illustrated. Particularly, FIG. 6A shows a side view of the locking mechanism 50 having a bolt 51 and a sliding handle 52. The bolt 51 has a cylindrical head 53 for support and a threaded portion 54 for fastening. In the case a portion of the first end 32 of the rotating frame 30 is threaded, the pitch angle and distance of the threading should match the threaded portion 54 for effective binding. The sliding handle 52 is loosely positioned through the cylindrical head 53 via a conduit (not shown), having a slightly larger diameter than the sliding handle 52. Each end of the sliding handle 52 has a rivet 55,56, for instance, a mushroom or round head rivet, which acts as a stopper on the sliding handle 52 and holds the sliding handle 52 at its edges on both sides. Alternately, the stopper arrangement on the sliding handle 52 can be realized by means of a spot weld at both ends.

The sliding nature of the handle 52 provides additional flexibility in the fastening operation since the bolt 51 can be rotated from both sides. The diameter of the threaded portion 54 of the bolt 51 corresponds to the diameter of the screw hole 26 on the hollow cylinder 24 of the main frame 20. The diameter D_{bolt} of the cylindrical head 53 of the bolt 51 is preferably larger than the diameter Dₕₒₗₑ of the threaded portion 54, for instance, about 15 mm, in order to support the threaded portion 54 along the screw hole 26, especially on the outer surface of the hollow cylinder 24.

Along FIG. 6B, a front view of the locking mechanism 50 is illustrated. Here, the axial position of the sliding handle along with a rivet 56 on one end are projected with respect to the dimensions of the bolt 51.

Along FIG. 6C, a top view of the locking mechanism 50 is shown. Herein, the direction of movement for the sliding handle 52 through the cylindrical head 53 is projected along with the axial positions of the rivets 55,56 with respect to the sliding handle 52.

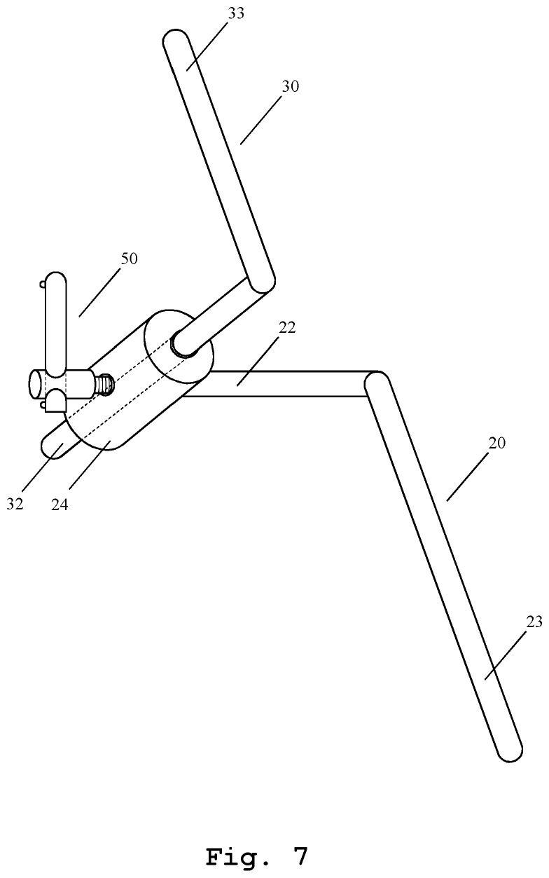

In FIG. 7, a three-dimensional view of an exemplary arrangement of the main frame 20, rotating frame 30 and the locking mechanism 50 according to the first aspect of the invention is illustrated. It can be clearly depicted that the rotating frame 30 is arranged through the hollow cylinder 24 of the main frame 20 in a manner that the rotating frame 30 can allow a 360 degree rotation along the hollow cylinder 24 and can further be moved through it. In particular, the first end 32 of the rotating frame 30 is perpendicular to the fixed end 22 of the main frame 20. However, the second end 33 of the rotating frame 30 can be arranged parallel or perpendicular or at any angle with respect to the fixed end 22 resp. the free end 23 of the main frame 20 and can be fixed by means of the locking mechanism 50. As a result, a number of degrees of freedom is facilitated with regard to the positioning of the device.

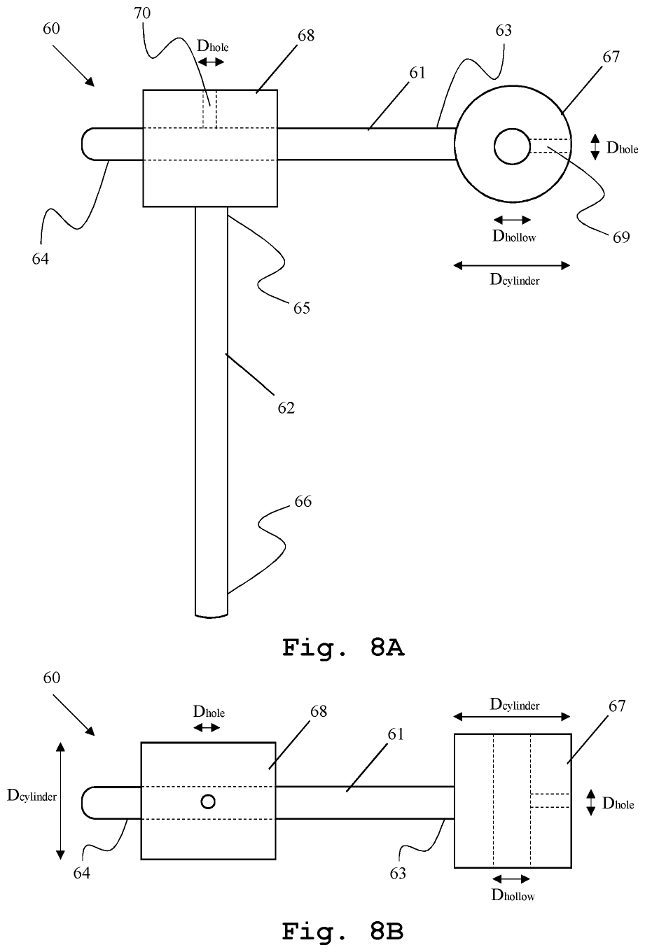

Along FIG. 8A and FIG. 8B, a second exemplary embodiment of the main frame 60 according to the first aspect of the invention are illustrated. Here, the main frame is segmented in two, preferably identical segments, a first frame segment 61 and a second frame segment 62. The first frame segment 61 has a fixed end 63 and a free end 64, where the fixed end 63 is attached to a hollow cylinder 67. Similarly, the second frame segment 62 has a fixed end 65 and a free end 66, where the fixed end 65 is attached to a further hollow cylinder 68. Preferably, the hollow cylinder 67 of the first frame segment 61 resp. the hollow cylinder 68 of the second frame segment 62 are symmetrical to the hollow cylinder 24 of the main frame 20 illustrated in FIG. 3A.

Thus, the hollow cylinder 67 of the first frame segment 61 comprises a screw hole 69 threaded on the opposite side of the fixed end 63. Likewise, the hollow cylinder 68 of the second frame segment 62 comprises a screw hole 70 threaded on the opposite side of the fixed end 65. The screw holes 69,70 are preferably symmetrical to the screw hole 26 on the hollow cylinder 24 of the main frame 20 illustrated in FIG. 3A, thereby configuring each of the screw holes 69,70 adapted to accept the locking arrangement 50, especially the threaded section 54 of the bolt 51. In this context, the hollow cylinder 67 of the first frame segment 61 encompasses the first end 32 of the rotating frame 30 such that the rotating frame 30 is able to move along its length as well as to rotate along the hollow cylinder 67. A locking mechanism 50 is attached to the hollow cylinder 67 of the first frame segment 61 via the screw hole 69 in order to fix the rotating frame 30 at a certain length and a certain angle.

On the other hand, the hollow cylinder 68 of the second frame segment 62 encompasses the free end 64 of the first frame segment 61 such that the first frame segment 61 is able to move along its length, especially perpendicular to the second frame segment 62. Furthermore, the first frame segment 61 is able to rotate along the hollow cylinder 68 of the second frame segment 62. A further locking mechanism 50 is attached to the hollow cylinder 68 of the second frame segment 62 via the screw hole 70 in order to fix the first frame segment 61 at a certain length and a certain angle.

As an alternative to the use of locking mechanism 50 on the second frame segment 62, the free end 64 of the first frame segment 61 may be extensively threaded and may be attached to the second frame segment 62 through the hollow cylinder 68. In this case, the first frame segment 61 can be adjusted by means of a detachable nut, placed along any side of the hollow cylinder 68, with threaded hole symmetrical to the threading of the free end 64 of the first frame segment 61. As a result, by applying external rotation on the nut, an adjustment on the length as well as the angular position of the first frame segment 61 can be achieved with respect to the second frame segment 62.

Along FIG. 8B, a top view of the main frame 60 is shown. Especially, the axial position of the hollow cylinder 68 of the second frame segment 62 with respect to the first frame segment 61 is visually projected. It is to be noted that the length of the first frame segment 61 may differ with regard to the length of the second frame segment 62 in order to maintain the effective dimensions of the main frame 20 disclosed previously. However, the shape and the diameter of the first frame segment 61 resp. the second frame segment 62, e.g., for the respective members, are preferably identical to the main frame 20.

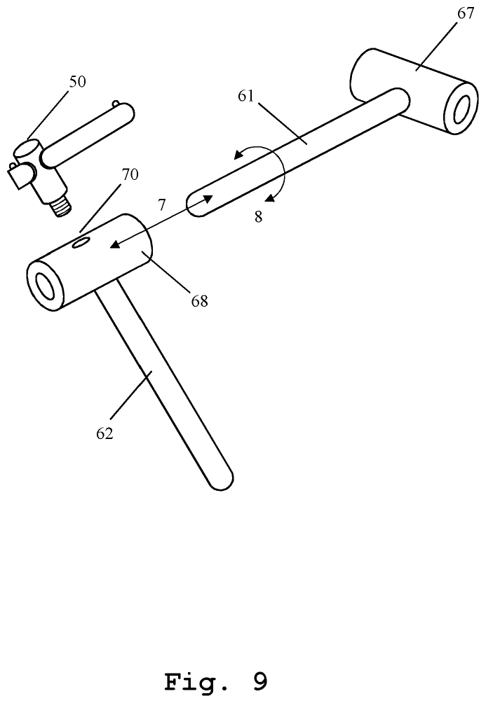

In FIG. 9, a three-dimensional view of the second exemplary embodiment of the main frame 60 according to the first aspect of the invention is illustrated. Herein, the first frame segment 61 and the second frame segment 62 are shown in a detachable manner. The first frame segment 61 is arranged through the hollow cylinder 68 of the second frame segment 62 along a lateral axis 7, where the first frame segment 61 is movable through the hollow cylinder 68 along the said axis 7. The first frame segment 61 is further able to rotate within the conduit of the hollow cylinder 68 along a rotating axis 8.

The locking mechanism 50 that is arranged at the screw hole 70 of the hollow cylinder 68 fixes the first frame segment 61 at a certain lateral displacement and a certain rotational angle with respect to the second frame segment 62. The hollow cylinder 67 of the first frame segment 61 allows the first end 32 of the rotating frame 30 to move laterally as well as rotationally within the conduit. An additional locking mechanism 50 (not shown) fixes the first end 32 resp. the rotating frame 30 at a certain linear displacement and a certain rotational angle.

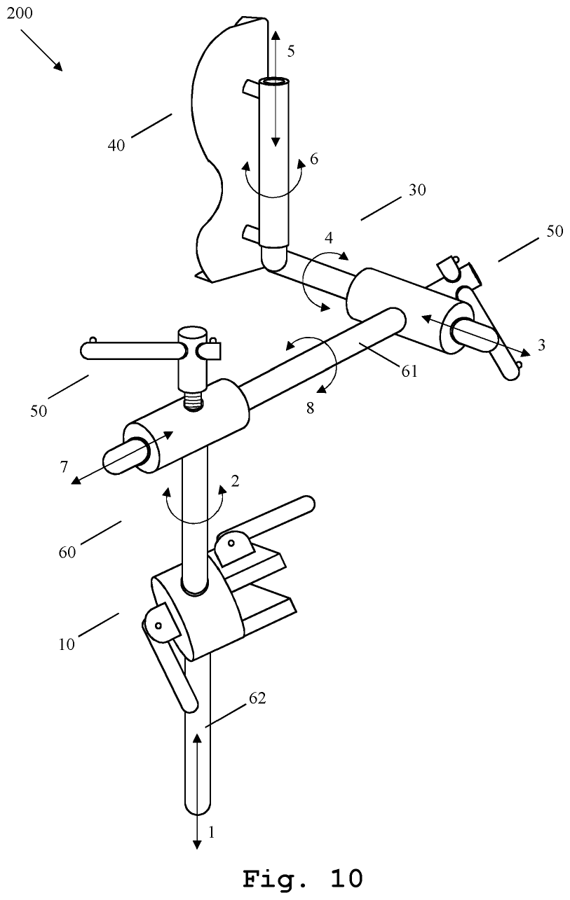

In FIG. 10, a three-dimensional view of a second exemplary embodiment of the device 200 according to the first aspect of the invention is illustrated. The device 200 differs from the device 100 of FIG. 1 in that the device 200 comprises the main frame 60, which is further segmented into the first frame segment 61 and the second frame segment 62. As such, the device 200 facilitates additional degrees of freedom of operation. In particular, the second frame segment 62 of the main frame 60 is able to move linearly along the first lateral axis 1 through the support fixture 10, thereby allows for adjustment of the effective height of the device 200. The second frame segment 62 is further able to rotate along the first rotational axis 2, which allows for an angular adjustment of the device 200 with respect to, for instance, the surface plane of the operating table.

The rotating frame 30 can be moved linearly along the second lateral axis 3, which allows for an easy adjustment for the effective placement of the device 200, for instance, in order to adapt with different patients heights. The rotating frame 30 is further able to rotate along the second rotating axis 4 that facilitates the rotation of the foot plate 40 by 360 degrees. In addition, the foot plate 40 is able to move linearly along the third lateral axis 5 and is further able to rotate along the third rotational axis. This especially allows for easy detachment/reattachment of a foot on the foot plate 40 resp. on the device 200 and an easy positioning of a foot on the foot plate 40.

Moreover, the first frame segment 61 of the main frame 60 is able to move linearly along the fourth lateral axis 7 and is further able to rotate along the fourth rotational axis 8. Hence, two additional degrees of freedom are introduced, especially respect to the movement of the rotating frame 30 resp. the movement of the foot plate 40. In this context, the fourth lateral axis 7 is perpendicular to the first lateral axis 1, the second lateral axis 3 and the third lateral axis 5. Likewise, the fourth rotational axis 8 is perpendicular to the first rotational axis 2, the second rotational axis 4 and the third rotational axis 6.

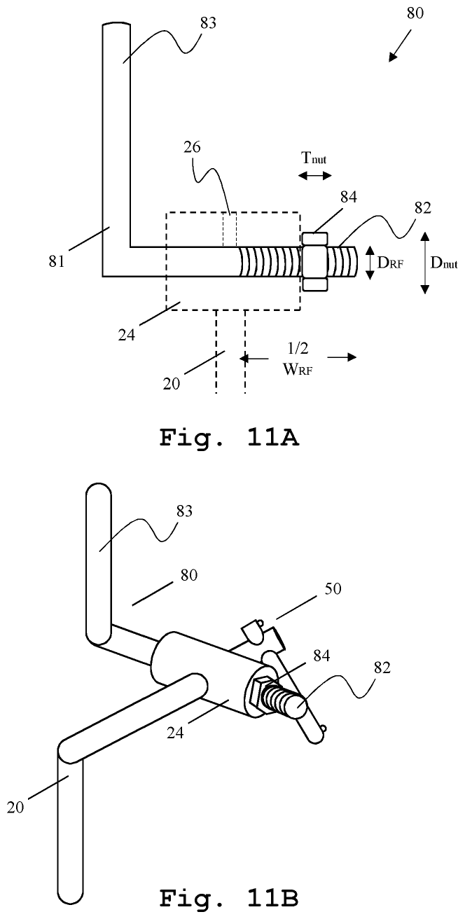

Along FIG. 11A and FIG. 11B, a second exemplary embodiment of the rotating frame 80 according to the first aspect of the invention are illustrated. In particular, FIG. 11A shows a side view of the rotating frame 80 that is arranged through the hollow cylinder 24 of the main frame 20. The rotating frame 80 comprises an L-shaped member 81 similar to the rotating frame 30 having a first end 82 and a second end 83. However, the first end 82 of the rotating frame 80, especially the distal half of the first end 82 is extensively threaded in such a way that a part of the threaded first end 82 is pushed out through the conduit of the hollow cylinder 24. A nut 84 is arranged at the first end 82 in order to tighten the rotating frame 80 against the distal face of the hollow cylinder 24 of the main frame 20.

Advantageously, tightening the nut 84 pulls the first end 82 of the rotating frame 80 through the conduit of the hollow cylinder 24 before the rotating frame 80 is externally rotated and then locked at a specific angle via the locking mechanism 50. This result in an application of traction to the leg attached to the foot plate 40. Preferably, the shape and dimensions of the rotating frame 80 are identical to the rotating frame 30. The nut 84 has an outer diameter Dₙᵤₜ slightly smaller than the diameter D_{cylinder} of the hollow cylinder 24, for instance, around 35 mm. Preferably, the nut 84 is substantially thick, for instance, having a thickness Tₙᵤₜ of about 20 mm, which allows for convenient external handling of the nut. A simple T-handle socket wrench can be used in order to handle the nut 84 externally.

Along FIG. 11B, a three-dimensional view for an arrangement of the second exemplary embodiment of the rotating frame 80 is shown. Especially, the axial positions of the rotating frame 80 and the nut 84 are projected with respect to the hollow cylinder 24 of the main frame 20. The locking mechanism 50 is also included within the illustrated arrangement. Although the arrangement depicts the main frame 20 according to the first exemplary embodiment as shown in FIG. 3A to FIG. 3C, it is readily comprehensible that the rotating frame 80 can also be arranged within the conduit of the hollow cylinder 67 of the main frame 60 as illustrated, for instance, in FIG. 8A. Hence, in addition to the extra degrees of freedom facilitated by the main frame 60, the rotating frame 80 further incorporates the application of traction to the leg attached to the device 100 resp. 200.

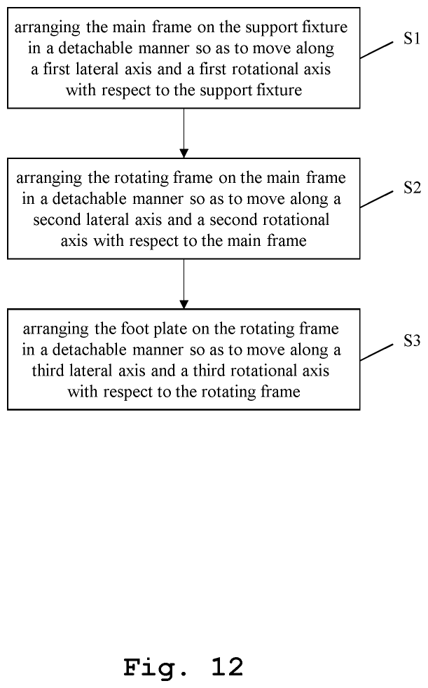

In FIG. 12, an exemplary embodiment of the method according to the second aspect of the invention is illustrated. In a first step S1, the main frame is arranged on the support fixture in a detachable manner so as to move along a first lateral axis and a first rotational axis with respect to the support fixture. In a second step S2, the rotating frame is arranged on the main frame in a detachable manner so as to move along a second lateral axis and a second rotational axis with respect to the main frame. Finally, in a third step S3, the foot plate is arranged on the rotating frame in a detachable manner so as to move along a third lateral axis and a third rotational axis with respect to the rotating frame.

While various embodiments of the present invention have been described above, it should be understood that they have been presented by way of example only, and not limitation. Numerous changes to the disclosed embodiments can be made in accordance with the disclosure herein without departing from the spirit or scope of the invention. Thus, the breadth and scope of the present invention should not be limited by any of the above described embodiments. Rather, the scope of the invention should be defined in accordance with the following claims and their equivalents.

Although the invention has been illustrated and described with respect to one or more implementations, equivalent alterations and modifications will occur to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

1. A leg-holding device for hip or knee surgery comprising:
a support fixture adapted to fasten the device on an edge of a surface,
a main frame arranged on the support fixture in a detachable manner, adapted to move along a first lateral axis and a first rotational axis with respect to the support fixture,
a rotating frame arranged on the main frame in a detachable manner, adapted to move along a second lateral axis and a second rotational axis with respect to the main frame, and
a foot plate arranged on the rotating frame in a detachable manner, adapted to move along a third lateral axis and a third rotational axis with respect to the rotating frame.

2. The device according to claim 1,
wherein the first lateral axis and the first rotational axis are parallel to the third lateral axis and the third rotational axis respectively, and
wherein the first and third lateral axes and the first and third rotational axes are perpendicular to the second lateral axis and the second rotational axis respectively.

3. The device according to claim 1,
wherein the support fixture comprises a first fastening element and a second fastening element, where the first fastening element is adapted to fasten the main frame at a given lateral displacement along the first lateral axis and a given rotational angle along the first rotational axis, and
wherein the second fastening element is adapted to fasten the support fixture on the edge of the surface.

4. The device according to claim 1,
wherein the main frame comprises a L-shaped member having a fixed end and a free end and a hollow cylinder, where the fixed end is attached to a midpoint of the hollow cylinder and the free end is arranged on the support fixture.

5. The device according to claim 1,
wherein the rotating frame comprises a L-shaped member having a first end and a second end, where the first end is arranged through the hollow cylinder perpendicular to the fixed end of the main frame.

6. The device according to claim 4,
wherein the hollow cylinder comprises a screw hole opposite to the fixed end of the main frame.

7. The device according to claim 1,
wherein the device further comprises a locking mechanism arranged at the screw hole, adapted to fasten the first end of the rotating frame at a given lateral displacement along the second lateral axis and a given rotational angle along the second rotational axis.

8. The device according to claim 1,
wherein the foot plate comprises a vertical support plate and a horizontal support plate attached on a surface perpendicular to each other.

9. The device according to claim 1,
wherein the foot plate further comprises a hollow cylindrical tube attached to the back of the foot plate, adapted to be positioned on the second end of the rotating frame at a given lateral displacement along the third lateral axis and a given rotational angle along the third rotational axis.

10. The device according to claim 1,
wherein the main frame further comprises a first frame segment and a second frame segment, each comprising a member having a fixed end and a free end, and
wherein the fixed ends of the members are attached to a respective hollow cylinder.

11. The device according to claim 1,
wherein the hollow cylinders of the first frame segment and the second frame segment each comprises a screw hole opposite to the respective fixed ends of the members in order to facilitate the locking mechanism.

12. The device according to claim 1,
wherein the free end of the first frame segment is arranged through the hollow cylinder of the second frame segment perpendicular to the member of the second frame segment and is further fastened by the respective locking mechanism at a given lateral displacement along a fourth lateral axis and a given rotational angle along a fourth rotational axis.

13. The device according to claim 1,
wherein the free end of the second frame segment is arranged on the support fixture and is fastened at a given lateral displacement along the first lateral axis and a given rotational angle along the first rotational axis.

14. The device according to claim 1,
wherein the support fixture, the main frame, the rotating frame, the foot plate and the locking mechanism are adapted to be sterilized in a compact arrangement.

15. A method for arranging a leg-holding device comprising a support fixture, a main frame, a rotating frame and a foot plate comprises the steps of:
arranging the main frame on the support fixture in a detachable manner so as to move along a first lateral axis and a first rotational axis with respect to the support fixture,
arranging the rotating frame on the main frame in a detachable manner so as to move along a second lateral axis and a second rotational axis with respect to the main frame, and
arranging the foot plate on the rotating frame in a detachable manner so as to move along a third lateral axis and a third rotational axis with respect to the rotating frame.
